(19) United States
(12) Patent Application Publication
(10) Pub. No.: US 2005/0224267 A1
(43) Pub. Date: Oct. 13, 2005

(54) Cooling system for a vehicular engine

(76) Inventor: James J. Callas, Peoria, IL (US)

Correspondence Address: CATERPILLAR INC.;100 N.E. ADAMS STREET, PATENT DEPT., PEORIA, IL, 616296490, US

(21) Appl. No.: 10/820,334

(22) Filed: Apr. 8, 2004

(51) Int. Cl. B60K 11/00

(52) U.S. Cl. 180/68.1

(57) ABSTRACT

A vehicle 10 has a frame 12 on which is positioned an engine 17. An engine enclosure 16 is at least partially positioned about the engine 17. A cooling system enclosure 18 is at least partially positioned about the engine 17 and about a conventional cooling media, such as a radiator 52. The radiator has a fluid 50 flowing there through to cooling the engine 17. A mass of ambient air 60 is used to cool the fluid 50. A partition 30 prevents the mass of ambient air 60 used to cool the fluid 50 from entering the engine enclosure 16.

### TECHNICAL FIELD

The present invention is directed generally to a cooling system for a vehicular application and more particularly to a method and apparatus for cooling an engine mounted in a fore of a vehicle.

### BACKGROUND

Cooling system requirements for vehicular applications have continued to increase for high performance engine and heavy-duty engine applications. In particular, emission standards have driven manufacturers to various solutions such as exhaust gas recirculation (“EGR”) and increasing manifold air pressure through the use of superchargers and turbochargers. In both cases, demand for cooling air has increased. Engine users also generally want increased performance read as higher horsepower or torque from these same engines. This increased performance generally requires more cooling of the engine structures further increasing the demand for cooling air.

In vehicular applications, cooling air is generally available in abundance. Cooling air may be used to cool a component directly such as flowing air over heat exchange fins connected with the component. Cooling air may also be used in a heat exchanger such as a radiator to cool a coolant that may be used to cool the component directly. While cooling air is available, frontal area on a vehicle is generally limited due to various concerns on performance and visibility from a passenger portion. Specifically, increasing the frontal area increases drag forces on the vehicle. Increases in power are needed to overcome the increased drag. Ultimately more fuel may be consumed to move the vehicle with the increased frontal area compared with the vehicle with no increase in frontal area.

As may be seen in U.S. Pat. No. 6,230,832 issued to von Mayenburg et al. on 15 May 2001, current cooling systems pass an incoming air mass through a radiator to cool an engine coolant. The incoming air mass is heated as it gains heat from the engine coolant. This same incoming air mass is then passed throughout the remainder of an engine bay with the belief that the temperature of the incoming air mass may be sufficiently low to provide direct cooling of an engine.

Alternatively, some applications place the radiator remotely from the engine such as shown in U.S. 2002/0053480 filed by William Pack on 11 May 1999 (also assigned to the applicant of the present application). Placing the radiator remotely allows for larger radiators and greater heat exchange area. However, a remote radiator may have a reduced mass flow of cooling air per unit of area of the radiator unless a fan has sufficient capacity to move the cooling air at an axial velocity equivalent to the forward velocity of the vehicle coupled with the axial velocity. The reduced mass flow may lower the cooling capacity below the cooling capacity of the front mounted radiator especially as forward velocity of the vehicle increases. Additionally, the fan able to move the cooling air at a velocity equivalent to the forward velocity of the vehicle may draw power from the engine and increase fuel consumption.

The present invention is directed to overcome one or more of the problems as set forth above.

### SUMMARY OF THE INVENTION

In one aspect of the present application a cooling system for a vehicle is comprised of a cooling system enclosure being positioned in a fore portion of the vehicle. An engine enclosure is positioned in the fore portion of the vehicle, the engine enclosure being aft of the cooling system enclosure and the engine enclosure being adapted to partially cover the engine. And, a partition separates the engine enclosure and the cooling system enclosure, the partition being adapted to substantially block a mass of ambient air from flowing through the cooling system enclosure and the engine enclosure.

In another aspect of the present application a vehicle is comprised of a frame and an engine attached to a fore position of the frame. An engine enclosure is positioned about the engine, the engine enclosure having an engine fore portion and an engine aft portion. A cooling enclosure is positioned fore of the engine enclosure, the cooling enclosure having an enclosure fore portion and an enclosure aft portion, the enclosure aft portion of the cooling enclosure being separated from the enclosure fore portion of the engine disclosure by a predetermined distance. A connecting member is positioned between the engine enclosure and the cooling enclosure. And, a partition connects with the engine fore portion of the engine enclosure, the partition being adapted to inhibit a mass ambient air flowing through the cooling enclosure from entering the engine enclosure through the engine fore portion of the engine enclosure.

### BRIEF DESCRIPTION OF THE DRAWINGS

FIG. 1 is a perspective view of a vehicle; and

FIG. 2 is a side view of a cab portion of the vehicle.

### DETAILED DESCRIPTION

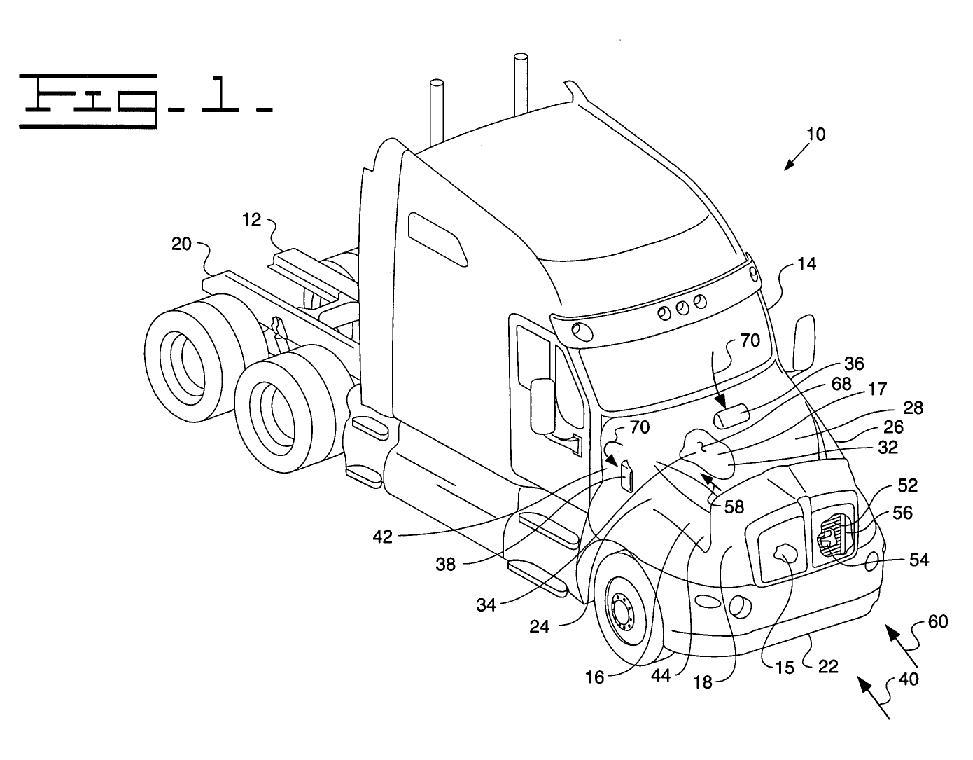

As shown in FIG. 1, a vehicle 10 includes a frame 12, a passenger portion 14, a cooling system 15, and an engine 17. The cooling system 15 includes an engine enclosure 16 and a cooling system enclosure 18. The passenger portion 14 may be attached to the frame portion between a vehicle aft portion 20 and vehicle fore portion 22 where the vehicle fore portion is toward a general direction of travel, designated as A, for which the vehicle is designed. The vehicle aft portion 20 is distal from the vehicle fore portion 22. In this application the engine is attach to the frame between the vehicle fore portion 22 and vehicle aft portion 20, however, as an alternative the engine could be attached at any a location along the frame.

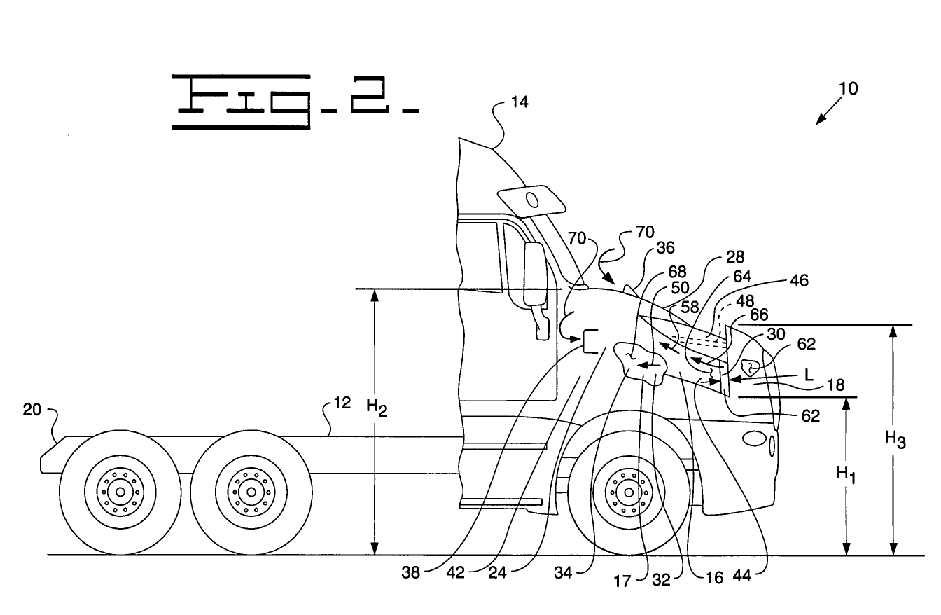

The engine enclosure 16 may include a first side portion 24 and second side portion 26 opposite the first side portion 24. A top portion 28 separates the first side portion 24 from the second side portion 26. The engine enclosure 16 at least partially covers the engine 17 above the frame 12. As shown in FIG. 2, a partition 30 connects with the engine enclosure 16 at or near an engine fore portion 32 of the engine enclosure 16. In the present embodiment, the first side portion 24, second side portion 26, top portion 28 and partition 30 are integral. The engine enclosure 16 may start at one of a height H1 at the engine fore portion 32 of the engine enclosure and transition to a height H2 at an engine aft portion 34 of the engine enclosure 16. The engine aft portion 34 being adjacent the passenger portion 14. The engine enclosure 16 may be of any conventional design including nacelle designs, conventional engine enclosures, and designs associated with partial with airfoil profiles. The engine enclosure 16 may include am air scoop 36 which promotes ambient air to flow through the engine enclosure. The air scoop 36 is positioned on the engine enclosure 16 or a vent or vents 38 are positioned on engine enclosure 16. An ambient air, designated by reference numeral 40, is generally defined as air generally at a pressures and a temperatures of the local environment around an exterior surface of the vehicle 10.

The cooling system enclosure 18 as shown in FIG. 2 is positioned fore of the engine enclosure 16. The cooling system enclosure has a height H3, an enclosure aft portion 42, and an enclosure fore portion 44. In the present embodiment the height H3 of the cooling system enclosure may be greater than the height H1 of the engine enclosure 16. A connecting member 46 may connect the cooling system enclosure 18 with the engine enclosure 16. The connecting members may also separate, at least partially, the engine system enclosure from the cooling system enclosure by a predetermined distance L. A cooling conduit 48 may pass through the connecting member providing fluid communication between the engine enclosure 16 and cooling system enclosure 18. A fluid, designated by reference numeral 50 is used as a cooling media and is positioned in the cooling system enclosure 18. The means for cooling the fluid 50 may be any conventional cooling system such as a liquid-to-fluid heat exchanger or fluid-to-fluid heat exchanger. In the present embodiment a conventional radiator 52 is positioned fore of a fan 54 that may be driven in a conventional manner such as electrically, hydraulically or mechanically. A shroud 56 downstream of the radiator 52 may direct a flow of heated air 58 away from the partition 30. The cooling system enclosure 18 may also include an air-to-air aftercooler (not shown), associated air inlet conduit (not shown), and air outlet conduit (not show) for delivering pressurized air to the engine 17.

In operation, a mass of ambient air 60 at a position X1, a temperature T1 and a pressure P1 passes through the enclosure fore portion 42 of the cooling system enclosure 18. The mass of ambient air 60 may pass over a heat exchanger. The mass of ambient air 60 exits the cooling enclosure system at a position X2 at a temperature T2, and is greater in temperature than T1, and is at a pressure P2, being greater than P1. The engine enclosure 16 inhibits the mass of ambient air 60 from flowing over the engine. Instead, the mass of ambient air 60 enters a first region 62 between the engine enclosure 16 and cooling system enclosure 18. As pressure of the mass of ambient air 60 builds in the first region 62 to a pressure P3, the mass of ambient air 60 exits to a second region or low pressure region 64 between the engine enclosure and the cooling system enclosure and is at a lower pressure P4 than that of the pressure P3. A portion of the mass of ambient air 60, designated as a second mass of ambient air 66, travels and accelerates along the surface of the cooling system enclosure while the pressure decreases to P4 at the second region 64. The lower pressure P4 draws the mass of ambient air 60 from the first region 62. The shroud 56 may also further facilitate directing the mass of ambient air 60 in first region 62 toward the second region 64 which is at the lower pressure P4.

The cooling fluid 50 exchanges heat with the mass of ambient air 60 as the mass of ambient air 60 passes through the cooling system enclosure 18. The cooling fluid 50 passes through the cooling fluid conduit 48 into the engine enclosure 16. The cooling fluid 50 circulates through the engine cooling various components. The engine may be further cooled by a second portion 66 of the mass of ambient air 60 passing through the air scoop 36 or the vents 40. In the present embodiment, a third region or high pressure region 68 below the engine enclosure 16 has a pressure of P5 being greater than a pressure P6 at the engine aft portion 34 of the engine enclosure 16. The second portion of the mass of air 66 is drawn from the high pressure region 68 through the engine enclosure to the engine aft portion 34 of the engine enclosure 16 and through the air scoop 36 or vents 40. A third mass of ambient air 70 may enter through the air scoop 36 or vents 40.

### INDUSTRIAL APPLICABILITY

The cooling system described in the present application is for use in the vehicle 10 having an engine 17 mounted in the vehicle fore portion 22. The cooling system enclosure 18 inhibits the mass of air 60 from flowing through both the engine enclosure 16 and the cooling system enclosure 18. In some instances, the mass of air 60 will reach temperatures T2 sufficiently elevated where flowing the mass of air 60 through the engine enclosure 16 and along the engine 17 will provide little or no benefit to cooling the engine or the components thereon.

Separating the cooling system enclosure 18 and engine system enclosure 16 may improve flow performance of the cooling system enclosure 18. The second region 64 having lower pressure P4 created by separating the cooling system enclosure 18 and engine enclosure 16 promotes lower pressures aft of the cooling system enclosure 18. The potential increase in difference between P1 and P2 allows for a greater flow of the mass of air 60. Similarly, the cooling fluid 50 will have greater cooling capacity to provide engine cooling.

It will be apparent to those skilled in the art that various modifications and variations can be made in the disclosed cooling system without departing from the scope or spirit of the invention. Other embodiments of the invention will be apparent to those skilled in the art from consideration of the specification and practice of the invention disclosed herein. It is intended that the specification and examples be considered as exemplary only.

1. A cooling system for a vehicle, said cooling system comprising:
a cooling system enclosure being positioned in a fore portion of said vehicle;
an engine enclosure being positioned in said fore portion of said vehicle, said engine enclosure being aft of said cooling system enclosure, said engine enclosure being adapted to partially cover said engine; and
a partition separating said engine enclosure and said cooling system enclosure, said partition being adapted to substantially block a mass of ambient air from flowing through said cooling system enclosure and said engine enclosure.

2. The cooling system of claim 1 further including a connecting member between said cooling system enclosure and said engine enclosure.

3. The cooling system of claim 2 further including a cooling conduit positioned in said connecting member.

4. The cooling system of claim 2 further including a means for cooling a fluid positioned in said cooling enclosure.

5. The cooling system of claim 4 wherein said means for cooling is a heat exchanger.

6. The cooling system of claim 5 further including a fan positioned aft of said means for cooling.

7. The cooling system of claim 6 further including a shroud positioned aft of said heat exchanger, said shroud being adapted to direct said mass of air away from said partition.

8. The cooling system of claim 1 wherein an enclosure aft portion of said cooling enclosure has a height H3 greater than a height H1 of an engine fore portion of said engine enclosure.

9. The cooling system of claim 1 where said partition is integral with said engine enclosure.

10. The cooling system of claim 1 further including a means for inducing additional ambient air.

11. A vehicle, said vehicle comprising:
a frame;
an engine attached to a fore position of said frame;
an engine enclosure positioned about said engine, said engine enclosure having an engine fore portion and an engine aft portion;
a cooling enclosure positioned fore of said engine enclosure, said cooling enclosure having an enclosure fore portion and an enclosure aft portion, said enclosure aft portion of said cooling enclosure being separated from said enclosure fore portion of said engine disclosure by a predetermined distance;
a connecting member positioned between said engine enclosure and said cooling enclosure; and
a partition being connected with said engine fore portion of said engine enclosure, said partition being adapted to inhibit a mass ambient air flowing through said cooling enclosure from entering said engine enclosure through said engine fore portion of said engine enclosure.

12. The vehicle of claim 11 further including a means for reducing an air pressure between said engine enclosure and said cooling enclosure.

13. The vehicle of claim 11 wherein said enclosure aft portion of said cooling enclosure is a height H1 and said engine fore portion of said engine enclosure is a height H2, said height H2 being less than said height H1.

14. The vehicle of claim 11 further including a heat exchanger positioned in said cooling enclosure and a fan positioned aft of said heat exchanger.

15. The vehicle of claim 14 further including a shroud positioned about said fan, said shroud being adapted to direct said mass ambient air away from said partition.

16. The vehicle of claim 11 further including a means for inducing additional ambient air.

17. A method for cooling an engine in a vehicle, said engine being positioned fore in said vehicle, said method comprising the steps of:
passing a mass of ambient air through a cooling enclosure;
exchanging heat between a cooling fluid and said mass of ambient air;
inhibiting the mass of ambient air from passing into said engine enclosure; and
directing said cooling fluid into said engine enclosure.

18. The method for cooling of claim 17 further including the step of reducing an air pressure between said engine enclosure and said cooling enclosure.

19. The method for cooling of claim 18 wherein said step of reducing includes accelerating an ambient air mass adjacent an enclosure aft portion of said cooling enclosure.

20. The method for cooling of claim 17 wherein said step of inhibiting includes blocking the mass of ambient air from entering an engine fore portion of said engine enclosure.
